(19) United States
(12) Patent Application Publication
(10) Pub. No.: US 2023/0215230 A1
(43) Pub. Date: Jul. 6, 2023

(54) METHOD AND APPARATUS FOR CONTROLLING A PASSAGE BARRIER

(71) Applicant: MOTOROLA SOLUTIONS, INC., Chicago, IL (US)

(72) Inventors: DANNY KAM, VANCOUVER (CA); PETER L VENETIANER, MCLEAN, VA (US); PIETRO RUSSO, MELROSE, MA (US)

(21) Appl. No.: 17/646,729

(22) Filed: Jan. 3, 2022

(51) Int. Cl. G07C 9/00; G07C 9/27

(52) U.S. Cl. CPC G07C 9/00309; G07C 9/27; G07C 2209/63

(57) ABSTRACT

A method and apparatus for controlling a passage barrier is provided herein. During operation the apparatus will determine a location of all persons authorized to enter through the barrier (e.g., a door). The apparatus will also determine the location of all persons not authorized for entry. Based on the location information, the passage barrier will remain open or closed. More particularly, based on the location information, a door, for example, may remain locked unless properly accessed by an authorized person. Additionally, based on the location information, the door may remain open for all to pass through.

### BACKGROUND OF THE INVENTION

At controlled-access points such as doors to office spaces, a passage barrier may be maintained in a closed and locked state, and a person typically must swipe in, for example using an access card, wait for authentication to occur, wait for a mechanical lock to unlock, and then proceed through the controlled access point once authenticated. However, such mechanisms have low person throughput and further have problems with tailgating, in which persons pass through passage barrier following an authenticated person and without being authenticated. It would be beneficial if an access point would allow a door to be unlocked when no unauthorized persons are nearby to facilitate faster ingress and egress. It would also be beneficial to only lock the door when unauthorized persons are detected. Furthermore, it would be beneficial if such a system can be utilized without the need for imaging equipment in order to maintain privacy.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for controlling a passage barrier, in accordance with some examples.

FIG. 2 is a device diagram showing a device structure of a device for controlling a passage barrier, in accordance with some examples.

FIG. 3 is a flowchart showing operation of the device for controlling a passage barrier.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a method and apparatus for controlling a passage barrier is provided herein. During operation the apparatus will determine a location of all persons authorized to enter through the barrier (e.g., a door). The apparatus will also determine the location of all persons not authorized for entry. Based on the location information, the passage barrier will remain open or closed. More particularly, based on the location information, a door, for example, may remain locked unless properly accessed by an authorized person. Additionally, based on the location information, the door may remain open for all to pass through.

In order to determine the location of all authorized persons the apparatus will utilize an ultra wideband (UWB) transceiver. The name “ultra-wideband” comes from the ability of the transceiver to transmit information across a wide radio bandwidth, from 500 MHz to several gigahertz. That gives all transmissions a short range. In one embodiment of the present invention, all UWB transceivers utilize the IEEE 802.15.4z standard for transmission and reception. Similarly other RF technologies may be used.

During operation, the apparatus will utilize the UWB transceiver to transmit a modulated wideband carrier signal to authorized devices (e.g., phones) held by authorized persons. The modulated wideband carrier signal will request credentials such as, but not limited to identification information from devices held by authorized persons. These devices will respond via transmitting their own modulated wideband carrier signal back to the UWB transceiver. The response transmitted by the devices will include credentials. Locating all responding devices will then take place. More particularly, known location techniques such Angle of Arrival (AOA), Time Difference of Arrival (TDOA), trilateration, ... , etc. may be utilized to locate all responding devices based on their transmissions. Additionally, the responding devices may provide their own location information to the apparatus via their modulated UWB transmissions. More particularly, the responding device may be equipped with location-finding equipment such as a GPS receiver. The location-finding equipment is utilize to determine a location of the responding device. This location may be provided via their modulated UWB transmissions. The location of any responding device will be used as a proxy for the location of a user of that device. If the device is authorized, then the user of that device will be assumed to be authorized.

During operation the apparatus will also utilize the UWB transceiver to transmit an wideband carrier signal to detect the presence of any person within range of the carrier signal. The carrier signal will be utilized as a UWB impulse-radar. The apparatus will detect reflections of the UWB carrier signal to determine person’s locations utilizing UWB radar technology as described in “Location Detection and Tracking of Moving Targets by a 2D IR-UWB Radar System” by Nguyen et al (Department of Information and Communication Engineering, Chosun University, 375 Susuk-Dong Dong-gu, Gwangju 501-759, Korea).

Once the location of authorized persons is known, and once the location of all persons are known, the apparatus will be able to compare the two and determine a location for all unauthorized persons. This is accomplished by determining those persons, located via radar, that have no corresponding authorized device associated with them. The passage-barrier may be controlled based on the location of authorized and unauthorized persons.

Expanding on the above, once a location of authorized and unauthorized persons are known, the apparatus may lock or unlock the entry point based on, for example, the following:
The entry point may remain unlocked so long as no unauthorized persons are detected.
The entry point may remain unlocked so long as no unauthorized person is a closest person to the entry point.
A warning maybe given if there is an unauthorized person near the authorized person to watch out for unauthorized person.
The default maybe to keep the door locked, and unlock only if authorized person is detected nearby, closer than any unauthorized person.

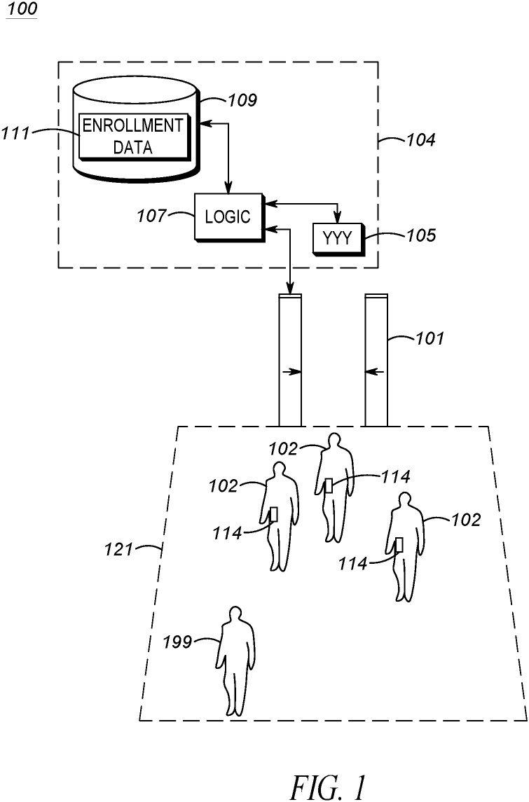

Attention is directed to FIG. 1, which depicts an example system 100 for controlling a passage barrier. The various components of system 100 are in communication via any suitable combination of wired and/or wireless communication links, and communication links between components of system 100 are depicted in FIG. 1, and throughout the present specification, as double-ended arrows between respective components; the communication links may include any suitable combination of wireless and/or wired links and/or wireless and/or wired communication networks.

System 100 comprises passage barrier 101 through which authorized persons 102, located in area 121, may pass. For example, system 100 further comprises access controller 104 that, as depicted, comprises UWB transceiver 105, computing device 107 (sometimes referred to as logic circuitry), and database 109 (e.g., a memory in communication with logic circuitry 107). Database 109 is configured to store enrollment data 111 used to authenticate authorized persons 102. For example, enrollment data 111 may comprise credentials for those persons allowed to enter through passage barrier 101 (e.g. one or more values that represent credentials for those allowed to enter through barrier 101). Those allowed to enter through passage barrier 101 are referred to herein as “authorized persons” 102.

UWB transceiver 105 comprises a transmitter and receiver, and is configured to transmit and receive UWB radio frequency signals to and from area 121, and is utilized along with logic circuitry 107 to determine both a geographic location for authorized persons (via their devices) and a geographic location from all persons present in area 121 (via UWB radar). Logic circuitry 107 will then use this information to determine a location of unauthorized persons within area 121 and either lock or unlock barrier mechanism 101 based on the above locations.

In some examples, passage barrier 101 may comprise a door, a double door, a gate, a portal, an entrance, a turnstile, an exit, and the like through which passage is electronically controlled. Passage barrier 101 may be located at an entrance and/or an exit to a building, and the like, through which passage is electronically controlled. While passage barrier 101 is depicted as a physical barrier mechanism, passage barrier 101 may additionally and/or alternatively comprise any suitable non-physical barrier mechanism through which passage is controlled, for example, using electromagnetic fields, disorienting holograms, or another non-visible type of barrier mechanism that may be used prevent passage therethrough. In the depicted examples, passage barrier 101 comprises physical double doors, and each of the double doors may be electronically locked, unlocked, opened and/or closed; in particular, when both double doors are open, multiple authorized persons 102 may enter and/or exit therethrough simultaneously.

It should be noted that system 100 may further comprise an authentication system (not shown in FIG. 1), such as a card reader (as depicted), and the like, for example located adjacent passage barrier 101 that may optionally be used as an additional factor to authenticate authorized persons 102 for passage through passage barrier 101.

As shown in FIG. 1, authorized persons 102 also carry mobile devices 114 which may store credentials (e.g., identification information, tokens,..., etc.) for authentication via UWB techniques described above, and be configured to interact with the controller 104 (such mobile devices will include at least one UWB transceiver) to authenticate authorized persons 102 using such credentials. Also, as shown in FIG. 1, unauthorized person 199 either carries no device 114, or any device carried by person 199 has insufficient credentials (or no credentials), and cannot be authenticated. (To be “authenticated” means to be a confirmed authorized person/device that is allowed to enter through passage barrier 101).

As is evident, access controller 104 and/or logic circuitry 107 is in communication with passage barrier 101 and controls passage barrier 101 to different states including, but not limited to, an open state, a closed state, an unlocked state, a locked state, and the like, as described hereafter, based on locations of persons 102 and 199.

Unauthorized person 199 may comprise a person who is not authorized to pass through passage barrier 101. In some examples, the unauthorized person 199 may carry a device that is not associated with enrollment data 111 and access controller 104 and/or logic circuitry 107 may determine that person 199 is unauthorized by acquiring no enrollment data 111 via UWB transmissions, or alternatively, by acquiring improper enrollment data via UWB transmissions (no matching enrollment data 111 is found within database 109).

In other examples, unauthorized person 199 may be associated with a device having enrollment data 111; however, the enrollment data may be on a blacklist, and the like, and/or a former employee, and the like for which respective enrollment data 111 was previously generated. In these examples, access controller 104 and/or logic circuitry 107 may determine that a device carried by person 199 is unauthorized since they are on a blacklist, and/or when an associated respective enrollment data 111 is found that is associated with the blacklist.

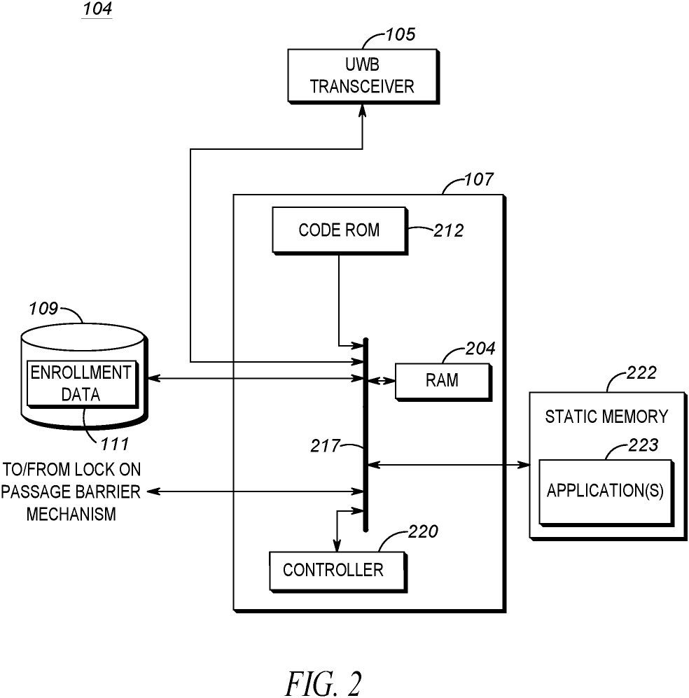

Attention is next directed to FIG. 2 which depicts a schematic block diagram of an example of device 104. Device 104 comprises logic circuitry 107. In general, logic circuitry 107 may comprise one or more servers and/or one or more cloud computing devices, and the like, configured to communicate with passage barrier 101. Device 104 also comprises UWB transceiver 105, and database 109. Logic circuitry 107 may comprise a computing device such as a personal computer and/or a laptop computer, and the like. In some examples, logic circuitry 107 may be combined with UWB transceiver 105 and/or any other suitable device of system 100 (for example, access controller 104). Logic circuitry 107 may be located local or remote from passage barrier 101 and/or the other components of system 100.

As depicted, logic circuitry 107 comprises: Random-Access Memory (RAM) 204, code Read Only Memory (ROM) 212, common data and address bus 217, controller 220 in communication with static memory 222 storing at least one application 223.

While not shown in FIG. 2, device 104 may include one or more of an input device and a display screen and the like such that a person, such as a system administrator, and the like, may interact with device 104.

Controller 220 includes one or more logic circuits, one or more processors, one or more microprocessors, one or more ASIC (application-specific integrated circuits) and one or more FPGA (field-programmable gate arrays), and/or another electronic device. In some examples, controller 220 and/or logic circuitry 107 is not a generic controller and/or a generic device, but a device specifically configured to implement functionality for controlling a passage barrier. For example, in some examples, logic circuitry 107 and/or controller 220 specifically comprises a computer executable engine configured to implement functionality for controlling a passage barrier.

Static memory 222 is a non-transitory machine readable medium that stores machine readable instructions to implement one or more programs or applications. Example machine readable media include a non-volatile storage unit (e.g. Erasable Electronic Programmable Read Only Memory (“EEPROM”), Flash Memory) and/or a volatile storage unit (e.g. random-access memory (“RAM”)). In the example of FIG. 2, programming instructions (e.g., machine readable instructions) that implement the functional teachings of logic circuitry 107 as described herein are maintained, persistently, at the memory 222 and used by controller 220 which makes appropriate utilization of volatile storage during the execution of such programming instructions.

Device 104 shown in FIG. 1 comprises an apparatus comprising an ultra-wideband (UWB) transceiver, a database comprising enrollment data, the enrollment data utilized to determine people authorized to enter through a passage-barrier mechanism, and logic circuitry. The logic circuitry is configured to receive a plurality of modulated UWB signals from the UWB transceiver, the modulated UWB signals comprising enrollment data for each of a plurality of devices and a location for each of the plurality of devices, use the enrollment data received from each of the plurality of devices to compare with the enrollment data within the database to determine authorized devices from the plurality of devices, cause the same UWB transceiver to transmit an UWB signal from the UWB transceiver as a radar signal, determine a location for a plurality of people from the radar signal, compare the location for the plurality of people determined from the radar signal with the location for each of the plurality of authorized devices to determine a location of authorized and unauthorized users, and control the passage-barrier mechanism based on the location of the authorized and unauthorized users.

As discussed, the enrollment data comprises credentials for those persons allowed to enter through the passage barrier. Additionally, The logic circuitry may use the enrollment data received from each of the plurality of devices to determine the authorized users from the plurality of devices by accessing the database to determine if the enrollment data received from each of the plurality of devices comprises enrollment data that allows access.

The logic circuitry may also determine the location for the plurality of people from the radar signal by utilizing reflections of the UWB signal off of the plurality of people.

The logic circuitry may also control the passage barrier mechanism so that the passage barrier mechanism remains unlocked so long as no unauthorized persons are detected with the radar signal.

The logic circuitry may also control the passage barrier mechanism so that the passage barrier mechanism remains unlocked so long as no unauthorized person detected with the radar signal is a closest person to an entry point.

The logic circuitry may also control the passage barrier mechanism so that the passage barrier mechanism remains unlocked so long as no unauthorized persons are detected with the radar signal.

The logic circuitry may also control the passage barrier mechanism so that the passage barrier mechanism remains locked, and is unlocked only if authorized person is detected by the radar signal is closer to an entry point than any unauthorized person.

As discussed above, the logic circuitry may determine the location of authorized and unauthorized users by comparing the location for the plurality of people determined from the radar signal with the location for each of the plurality of authorized devices to determine co-located authorized devices and people detected from the radar signal, and tagging a person detected from the radar signal as unauthorized if they are not co-located with an authorized device.

It should be noted that the UWB transceiver can also configured to cause the UWB transceiver to transmit a modulated UWB signal from the UWB transceiver to a plurality of devices, the modulated UWB signal requesting enrollment data from the plurality of devices. Thus, enrollment data may not be transmitted from the plurality of devices unless requested.

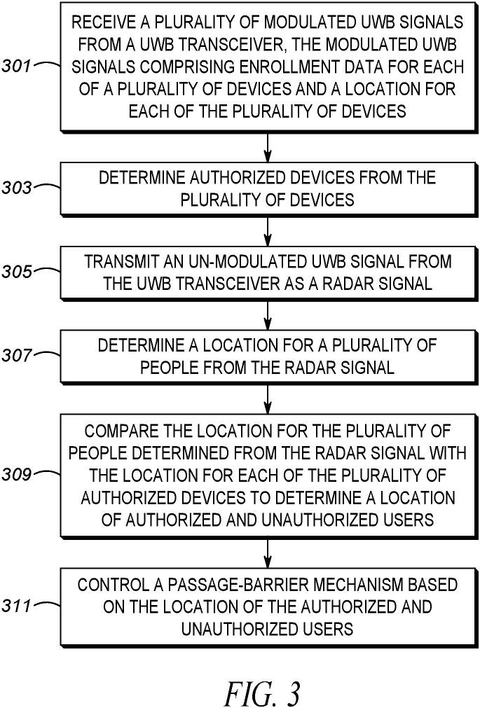

FIG. 3 is a flowchart showing operation of device 104 for controlling a passage barrier. The logic flow begins at step 301 where UWB transceiver 105 receives a plurality of modulated UWB signals from a UWB transceiver, the modulated UWB signals comprising enrollment data for each of a plurality of devices and a location for each of the plurality of devices. At step 303, logic circuitry 107 determines authorized devices from the plurality of devices. At step 305, logic circuitry causes UWB transceiver 105 to transmit a UWB signal from the UWB transceiver as a radar signal. A location for a plurality of people is determined from the radar signal at step 307. At step 309, logic circuitry 107 then compares the location for the plurality of people determined from the radar signal with the location for each of the plurality of authorized devices to determine a location of authorized and unauthorized users. Finally, at step 311 logic circuitry controls a passage-barrier mechanism based on the location of the authorized and unauthorized users.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one ...” and “one or more...” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ...a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An apparatus comprising:
an ultra-wideband (UWB) transceiver;
a database comprising enrollment data, the enrollment data utilized to determine people authorized to enter through a passage-barrier mechanism;
logic circuitry configured to:
receive a plurality of modulated UWB signals from the UWB transceiver, the modulated UWB signals comprising enrollment data for each of a plurality of devices and a location for each of the plurality of devices;
use the enrollment data received from each of the plurality of devices to compare with the enrollment data within the database to determine authorized devices from the plurality of devices;
cause the UWB transceiver to transmit a UWB signal from the UWB transceiver as a radar signal;
determine a location for a plurality of people from the radar signal;
compare the location for the plurality of people determined from the radar signal with the location for each of the plurality of authorized devices to determine a location of authorized and unauthorized users; and
control the passage-barrier mechanism based on the location of the authorized and unauthorized users.

2. The apparatus of claim 1 wherein the enrollment data comprises credentials for those persons allowed to enter through the passage barrier.

3. The apparatus of claim 1 wherein the logic circuitry uses the enrollment data received from each of the plurality of devices to determine the authorized users from the plurality of devices by accessing the database to determine if the enrollment data received from each of the plurality of devices comprises enrollment data that allows access.

4. The apparatus of claim 1 wherein logic circuitry determines the location for the plurality of people from the radar signal by utilizing reflections of the radar signal off of the plurality of people.

5. The apparatus of claim 1 wherein the logic circuitry controls the passage barrier mechanism so that the passage barrier mechanism remains unlocked so long as no unauthorized persons are detected with the radar signal.

6. The apparatus of claim 1 wherein the logic circuitry controls the passage barrier mechanism so that the passage barrier mechanism remains unlocked so long as no unauthorized person detected with the radar signal is a closest person to an entry point.

7. The apparatus of claim 1 wherein the logic circuitry controls the passage barrier mechanism so that the passage barrier mechanism remains locked, and is unlocked only if authorized person is detected by the radar signal is closer to an entry point than any unauthorized person.

8. The apparatus of claim 1 wherein the logic circuitry determines the location of authorized and unauthorized users by comparing the location for the plurality of people determined from the radar signal with the location for each of the plurality of authorized devices to determine co-located authorized devices and people detected from the radar signal, and tagging a person detected from the radar signal as unauthorized if they are not co-located with an authorized device.

9. The apparatus of claim 1 wherein the UWB transceiver is also configured to:
cause the UWB transceiver to transmit a modulated UWB signal from the UWB transceiver to a plurality of devices, the modulated UWB signal requesting enrollment data from the plurality of devices.

10. A method comprising the steps of:
receiving a plurality of modulated UWB signals from a UWB transceiver, the modulated UWB signals comprising enrollment data for each of a plurality of devices and a location for each of the plurality of devices;
determining authorized devices from the plurality of devices;
transmitting a UWB signal from the UWB transceiver as a radar signal;
determining a location for a plurality of people from the radar signal;
comparing the location for the plurality of people determined from the radar signal with the location for each of the plurality of authorized devices to determine a location of authorized and unauthorized users; and
controlling a passage-barrier mechanism based on the location of the authorized and unauthorized users.

11. The method of claim 10 wherein the enrollment data comprises credentials for those persons allowed to enter through the passage barrier.

12. The method of claim 10 wherein the enrollment data received from each of the plurality of devices is used to determine authorized devices from the plurality of devices by accessing a database to determine if the enrollment data received from each of the plurality of devices comprises enrollment data that allows access through the passage barrier.

13. The method of claim 10 wherein the location for the plurality of people is determined from the radar signal by utilizing reflections of the radar signal off of the plurality of people.

14. The method of claim 10 wherein the passage barrier mechanism is controlled so that the passage barrier mechanism remains unlocked so long as no unauthorized persons are detected with the radar signal.

15. The method of claim 10 wherein the passage barrier mechanism is controlled so that the passage barrier mechanism remains locked, and is unlocked only if authorized person is detected by the radar signal is closer to an entry point than any unauthorized person.
